(19) United States
(12) Patent Application Publication
(10) Pub. No.: US 2007/0138788 A1
(43) Pub. Date: Jun. 21, 2007

(54) Drainable tube and pipe fitting

(76) Inventors: John C. Argo, Amherst, NY (US); Rick N. Canell, Amherst, NY (US)

Correspondence Address: CALFEE HALTER & GRISWOLD, LLP, 800 SUPERIOR AVENUE, SUITE 1400, CLEVELAND, OH, 44114, US

(21) Appl. No.: 10/534,776

(22) PCT Filed: Nov. 14, 2003
(86) PCT No.: PCT/US03/36541

§ 371 Date: May 13, 2005

(51) Int. Cl. F16L 43/00

(52) U.S. Cl. 285/134.1

(57) ABSTRACT

A fitting for tube and/or pipe includes two legs formed at a nominal included angle that is other than a right angle. An example would be a nominal included angle of about 2°±.5° from a right angle. A fitting is also provided that is drainable under the influence or force of gravity. Methods of forming such fittings are also provided including various combinations of steps of bending, cutting and welding.

### RELATED APPLICATION

This application claims the benefit of U.S. Provisional Application No. 60/426,695, filed Nov. 15, 2002, the entire disclosure of which is fully incorporated herein by reference.

### BACKGROUND OF THE INVENTION

In industries that require high purity in fluid delivery systems, such as, for example, the biopharmaceutical and semiconductor industries, it is often a requirement that the fluid system be drainable. For example, a run of tubing may need to be joined to a flow control device such as a valve or other piece of tubing in such a manner that the tubing is non-horizontal, thereby allowing gravity to drain fluid from the tubing. Known tube fittings, for example, elbow fittings and T-fittings, have a nominal 90° angle between the centerlines of the tube legs. This right angle is typically held to tight manufacturing tolerances so that the end face is square and true for welding among other purposes. However, in order to join such a tube fitting to a non-horizontal tube that is angled (sloped) for drainability, it is known to miter cut the end of the fitting to produce an end face that extends at the desired angle (with respect to the horizontal centerline of the fitting end). However, the non-squared end face precludes the use of orbital welding equipment, which is commonly used for joining tube ends. Therefore, mitered tube ends must be manually welded, which increases cost and time and which lower repeatability of welds.

Thus, there is a need for a fitting that can be used in a drainable fluid system such as one that has non-horizontal runs so as to drain under the influence of gravity, with a fitting that can be conveniently welded such as by orbital welding for example,

### SUMMARY OF THE INVENTION

The present invention contemplates a fitting for tube and/or pipe conduits or other fluid components that is drainable under the influence or force of gravity so as to conveniently be installed in a drainable fluid system. In one embodiment, a fitting is provided that has two legs that form an included nominal angle between their centerlines other than a nominal right angle. In a specific embodiment the included nominal angle may be, for example, different from a right angle by two degrees ±.5 degrees. Since all known prior fittings are manufactured to a nominal right angle within conventional tolerances, the invention contemplates a drainable fitting such as, for example, a fitting that forms an included nominal angle other than a right angle that otherwise would be formed within conventional manufacturing tolerances.

In accordance with another aspect of the invention, a fitting is provided that has two legs that form an included nominal angle other than a right angle and wherein one or more of the end faces of the legs are generally normal or square to a central axis of the leg. This arrangement facilitates conventional welding techniques such as orbital welding for fittings that are not right angle fittings.

The invention also contemplates various techniques for manufacturing or forming fittings of the aforementioned variety. The invention is applicable to tube as well as pipe.

These and other aspects and advantages of the invention will be readily appreciated and understood by those skilled in the art based on the following description of the exemplary embodiments in view of the accompanying drawings.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is an illustration of a fitting in accordance with the invention, shown connected with a schematically illustrated fluid system portion;

FIG. 2 is an enlarged view, partially in section, of the fitting of FIG. 1;

FIG. 3 is a view similar to FIG. 2 of a fitting with the same bend angle as the fitting of FIG. 1 but constructed in accordance with a second embodiment of the invention;

FIG. 4 is a view similar to FIG. 2 of a fitting with a different bend angle than the bend angle of the fitting of FIG. 1;

FIG. 5 is a view similar to FIG. 3 of a fitting with the same bend angle as the fitting of FIG. 4 but constructed in accordance with the second embodiment of the invention;

FIG. 6 is an illustration of a portion of a fluid system including several fittings of the present invention;

FIG. 7 is an illustration of a portion of another fluid system including several fittings of the present invention;

FIG. 8 is an illustration of a portion of another fluid system including one fitting of the present invention; and

FIG. 9 is an illustration of a portion of still another fluid system including one fitting of the present invention.

### DETAILED DESCRIPTION OF THE INVENTION

The invention provides a fitting for conduits such as tube and pipe that is drainable under the influence or force of gravity, so as to be conveniently installable in a drainable fluid system. Still further the invention provides a drainable fitting that can be welded by convenient techniques such as orbital welding. While the exemplary embodiments described herein relate to described nominal angles and exemplary tolerances, those skilled in the art will readily appreciate that the invention may be used for a fitting with a wide variety of included nominal angles and desired tolerances but that differ from a nominal right angle otherwise manufactured within conventional manufacturing tolerances. As used herein the term conduit includes tube and pipe.

By nominal herein is meant the desired or preferred value, in this case of the included angle.

FIG. 1 illustrates schematically a fitting 10 in accordance with the present invention. The fitting 10 is illustrated as being disposed below a fluid component or system portion indicated schematically at 12. The component or portion 12 may be a valve, a container, a conduit or any portion of a fluid system. Together, the fitting 10 and the component 12 form a drainable assembly 14. As described below in detail, the fitting 10 has a leg portion that extends at an angle to the horizontal so that a conduit section 16 connected with the fitting can drain the component or portion 12, as well as the fitting 10 itself. Although the invention finds particular application for drainable fluid systems, the invention may also be used in fluid systems where drainability is not required, for example, a system having difficult plumbing angles.

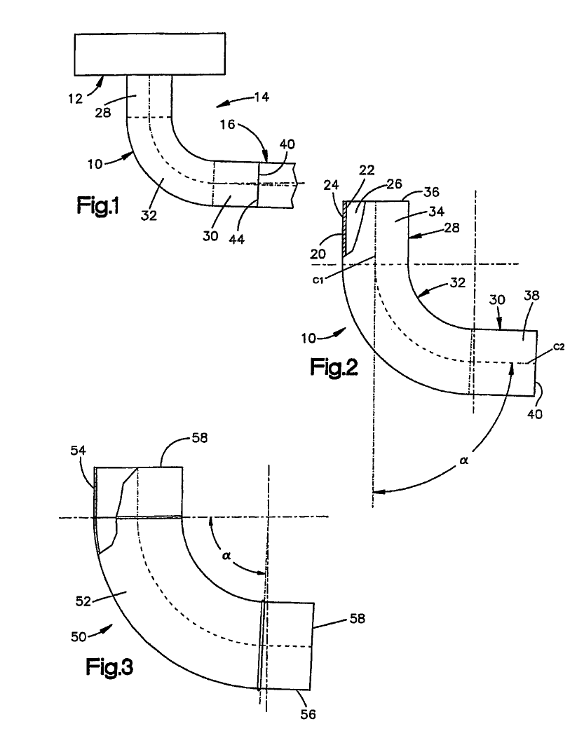

The fitting 10, shown in more detail in FIG. 2, is illustrated as being an elbow type tube fitting. The present invention is applicable to pipe fittings as well as to tube fittings. The present invention is also applicable to fittings other than the elbow fitting shown in FIGS. 1 and 2. Thus, the term “fitting” as used herein is intended to be broad in scope, encompassing all types of tube fittings and pipe fittings, for example and not by way of limitation, T-fittings, as well as tube stubs on fluid flow equipment.

Fittings in accordance with the present invention may be made from differing materials and are not limited to any particular material. For example, one preferred material is stainless steel. Other metals are suitable. Plastics may also be used.

The fitting 10 (FIG. 2) includes a wall 20 having coextending, inner and outer major side surfaces 22 and 24. The inner surface 22 defines a fluid flow passage 26 that extends through the fitting 10.

The fitting 10 has a first straight section 28 and a second straight section 30 that are joined by a bend section 32 which in this example is a curve. The geometric contour of the fitting is exemplary and may be of any suitable form, fit and function for a specific application. The first straight section 28 terminates in a first end portion 34 of the fitting 10 that has a first end face 36. The first end face 36 extends generally perpendicular to the centerline C1 of the first straight section 28 of the fitting 10.

The second straight section 30 terminates in a second end portion 38 of the fitting 10 that has a second end face 40. The second end face 40 extends generally perpendicular to the centerline C2 of the second straight section 30 of the fitting 10. The inner and outer surfaces 22 and 24 of the fitting 10 extend between and terminate at the first and second end faces 36 and 40.

In accordance with a feature of the invention, the curved section 32 of the fitting 10 has an angular extent or bend to form an included angle (designated “alpha” in FIG. 2) that is nominally other than a right angle or ninety degrees. Prior art fittings are manufactured to a nominal ninety degrees within a conventional manufacturing tolerance. Thus, the invention contemplates a fitting having leg portions with an included nominal angle between their centerlines other than ninety degrees outside conventional manufacturing tolerances of a nominal ninety degree fitting. In particular, the curved section 32 has a nominal included angle that is selected to enable the fitting 10 to be self-draining (drainable), and to enable a conduit or other fluid flow device that is connected with the fitting (for example, the added conduit section 16 shown in FIG. 1) to be drainable or self-draining under the influence or force of gravity although the exemplary embodiments herein illustrate the included angle as being formed by a curved portion or bend in the flow path, those skilled in the art will readily appreciate that the invention may be used with a wide variety of flow path geometry. Thus, the invention is directed to the use of an included angle other than a right angle and not limited by the geometry or profile of the flow path.

In the illustrated embodiment, the curved section 32 has a nominal included angle of 88°. The fitting 10 is made with a manufacturing tolerance, for the included angle, of plus or minus one half degree, for example, but other tolerances may be used. Thus, an exemplary angular range of the included angle for the fitting 10, may be 88°±½°. The invention contemplates nominal included angles greater than 90° and less than 90° or both depending on the particular application.

Because the nominal included angle of the fitting 10 is other than 90°, the second straight section 30 of the fitting does not extend horizontally when the first straight section 28 is vertical, as shown for example in FIG. 1. Rather, the second straight section 30 of the fitting 10 extends (slopes) downward from the horizontal, as it extends away from the curved section 32, when the first straight section 28 is vertical. As a result, the added section 16 (FIG. 1) extends (slopes) downward from the horizontal, as it extends away from the fitting 10, as shown in FIG. 1.

Because the added section 16 extends downward from the horizontal, as it extends away from the fitting 10, the added section is drainable. That is, fluid such as a liquid which flows into the section 16 from the fitting 10 has a tendency to flow downhill, away from the fitting, thus draining the fitting.

In addition, the fitting 10 itself is drainable, or self-draining. That is, fluid such as a liquid which flows into the fitting 10 from a fluid device 12 has a tendency to flow downhill, out of the second straight section 38 of the fitting, and out of the fitting altogether, thus draining the fitting. A fluid droplet, placed into or flowing along the interior passage 26 of the fitting, flows to a plurality of successively lower surface points along the inner surface 22, under the force of gravity, until leaving the fitting. The invention thus provides a fitting that is drainable and therefore usable in drainable fluid systems, but those skilled in the art will understand that a fluid component can meet the definition or requirement of drainability without requiring that the flow surfaces be completely clean or devoid of all fluid when the component is drained. Especially with shallow included angles of two degrees from normal for example, surface tension alone may prevent complete elimination of fluid from a fitting.

Fittings made in accordance with the present invention, thus have an intentional deviation from a right angle in the curved section of the fitting. This guarantees that a fitting that falls anywhere within its manufacturing tolerance range, will drain.

In contrast, a prior art fitting discussed above is made to a nominal angle of 90° in accordance for example with ASME specification BPE-2002. Thus, if a prior art fitting is, for example, used in place of the fitting 10 in the assembly of FIG. 1, the lower end of the fitting might extend horizontally, or might slope downward at an angle of up to one degree below horizontal, or might even slope upward at an angle of up to one degree above horizontal. Therefore, the prior art fitting is not per se usable if it is required that the fitting be drainable or that a fluid device connected with the lower end of the fitting be drainable.

In accordance with another feature of the invention, the fitting 10 is easily connected with the section 16 by a preferred but not required orbital welding technique. Specifically, the second end face 40 of the fitting 10 extends generally at a right angle to the centerline of the second straight section 30 of the fitting. When the fitting 10 is installed with the first straight section 34 vertical, the centerline of the second straight section 30 of the fitting extends at an angle of 88° to the first straight section, that is, at an angle of two degrees down from the horizontal. Because the second end face 40 of the fitting 10 extends at a right angle to the centerline of the second straight section 30 of the fitting, the second end face of the fitting thus extends at an angle of two degrees from the vertical. Accordingly, there is no bend or interruption in the cylindrical nature of the joined pieces and orbital welding can be conveniently used. This aids in welding a section to the fitting 10 when the section is to be drainable, that is, sloped downward.

As an example, the added section 16 shown in FIG. 1 has an end face 44, for connection with the fitting 10, that extends at a right angle to the centerline of the pipe section. Therefore, when the end face 44 of the added section 16 is secured to the second end face 40 of the fitting 10, the section extends parallel to (and is concentric with) the second straight section 30 of the fitting. The cylindrical outer surface of the second straight section 30 of the fitting 10 is therefore concentric with, and extends parallel to, the cylindrical outer surface of the section 16. As a result, the two pieces 10 and 16 can be orbitally welded.

For prior art right angle fittings, this is not possible if, for example, the tube section needs to extend two degrees off horizontal from the fitting, but the fitting straight section is horizontal—a proper weld can not be guaranteed. Therefore, having the second straight section 28 of the fitting 10 extend at a non-right angle to the horizontal not only provides a self-draining capability for the fitting, but also enables use of the desired automatic orbital welding process and equipment to connect the fitting in its fluid system. Where squareness of ends is required to allow for orbital welding, the present invention provides fittings that meet such a requirement.

The fitting 10 that is shown in FIGS. 1 and 2 is manufactured with the desired nominal included angle of 88° plus or minus one half degree. Thus manufacturing process can be used on any size tube or pipe, from as small as one half inch or less to as large as 4 inches or more. As discussed below, certain manufacturing considerations arise which might limit the applicability of this manufacturing process and suggest that other manufacturing processes, as also described below, are more suitable for certain tube and pipe sizes.

The preferred first step in manufacturing the fitting 10 with this process is to take a relatively long piece of stock of the desired diameter, for example, one inch. The stock may be, for example, a twenty-foot length of tube stock. This piece is then compound bent to form a plurality of fittings 10 each having the desired bend angle, all interconnected as one piece in a generally serpentine form. The individual fittings 10 are then cut from the stock piece and finished.

The finishing process may include cutting the straight sections 28 and 30 of the fittings 10 to the proper length; ensuring that the end faces 36 and 40 are square; and polishing the inner surface 22 of the fitting. The finishing process may also include treating the fitting 10 to remove stresses in the wall 20 that may have built up from the bending process. This treating may take the form of heat treating, for example, annealing. The annealing step can relieve internal stresses arising from bending. Heat treating might not be needed for some pieces, for example, smaller diameter fittings.

An alternative manufacturing process may be used, for example, if the needed volume of fittings is not sufficient to warrant investing in the machinery needed to perform the preferred compound bending process. Two such alternative processes are described below.

The first such process is preferably used with relatively small conduit sizes, for example, tubing sizes up to about one inch. This process starts with a fitting that is already manufactured with a nominal right angle (90°) curved section between two straight sections. The fitting is then bent to the desired off angle, for example, 88°±½°. The inner surface of the fitting is preferably polished, either before the bending step, or both before and after the bending step. The fitting can, if desired, be annealed to relieve stresses.

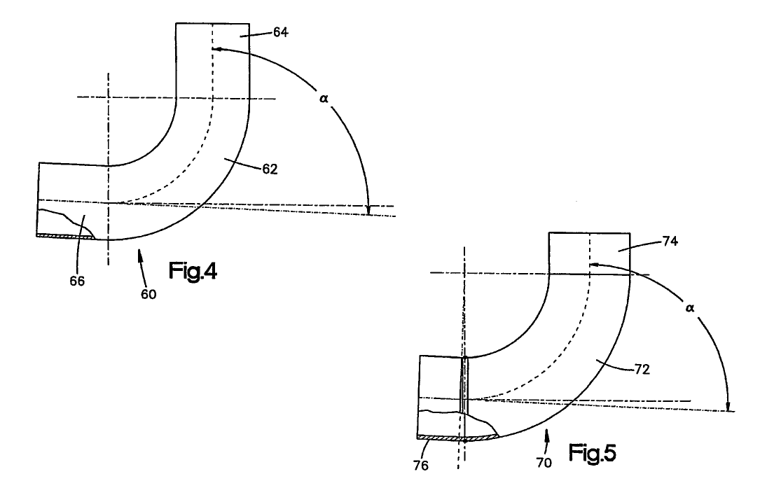

The second alternative process is preferably used with relatively large conduit sizes, for example, tubing sizes over two inches. The fitting 50 shown in FIG. 3 is an example of a fitting made by this process.

The fitting illustrated in FIG. 3 has a curved section 52 located between two straight sections 54 and 56. The curved section 52 has a nominal bend angle alpha with a measurement of 88°±½°. The first straight section 54 is welded on one end of the curved section 52. The second straight section 56 is welded on the opposite end of the curved section 52. The lengths of the two straight sections 54 and 56 are selected to ensure that the resulting fitting 50 has the proper overall dimensions between its end faces 58.

This process starts with a manufactured nominal right angle (90°) curved section. An end portion of the curved section of the fitting is then cut off the remainder. Enough of the curved section is cut off to ensure that the remaining part of the curved section has the desired nominal included angle. For example, two degrees may be cut from a 90° curved section to provide a nominal 88° curved section. First and second straight sections are then secured to opposite ends of the curved section, preferably by welding, to provide a fitting that has the proper overall dimensions.

In the resulting fitting 50, the two straight sections 54 and 56 extend at a nominal angle to each other than is other than a nominal right angle. In the illustrated embodiment, the two straight sections 54 and 56 extend at a nominal angle of 88°±½° to each other.

Another possible manufacturing process for these larger sized fittings involves starting with a manufactured right angle (90°) fitting including a curved section and two straight sections. One straight section and a small portion of the curved section of the fitting are then cut off the remainder. Enough of the curved section is cut off to ensure that the remaining part of the curved section has the desired angular extent. For example, two degrees may be cut from a 90° curved section to provide an 88° curved section. A new straight section is then secured to the cut end of the curved section, preferably by welding, to provide a fitting that has the proper overall dimensions.

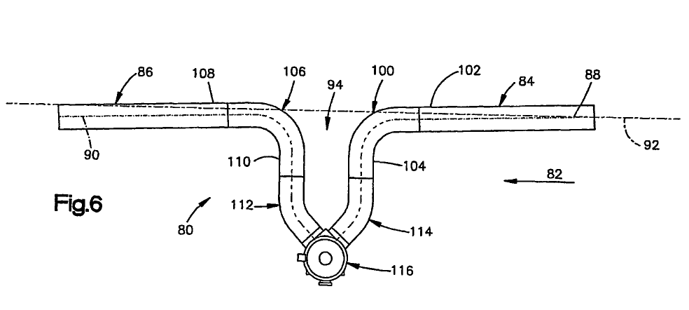

FIG. 4 illustrates another fitting 60 that is constructed in accordance with the present invention. The fitting 60 has a curved section 62 that extends between two straight sections 64 and 66. The fitting 60 is manufactured with a nominal included angle, denoted “alpha”, that is other than ninety degrees. Specifically, the fitting 60 has a nominal included angle of 92°±½°. The fitting 60 is usable in fluid systems in a manner as described below with reference to FIGS. 6-8, for example.

The fitting 60 is a one-piece fitting, as is the fitting 10 (FIGS. 1 and 2). The one-piece fitting 60 may be manufactured with any of the processes described above that are used for manufacturing one-piece fittings.

FIG. 5 illustrates a similar but multi-piece fitting 70 that is constructed in accordance with the present invention. The fitting 70 has a curved section 72 that extends between two straight sections 74 and 76. The fitting 70 has a nominal included angle, denoted “alpha”, that is other than ninety degrees. Specifically, the fitting 70 is manufactured with a bend angle of 92°±½°. The fitting 70 is usable in fluid systems in a manner as described below with reference to FIGS. 6-8, for example. The fitting 70 is a two-piece fitting, as is the fitting 50 (FIG. 3). The fitting 70 may be manufactured with any of the processes described above that are used for manufacturing two-piece fittings.

FIG. 6 illustrates a portion of a fluid system 80 that provides an example of use of fittings in accordance with the present invention. In the fluid system 80, liquid flows generally in a right to left direction as viewed in FIG. 6, as indicated by the arrow 82.

The system 80 includes a conduit that includes two co-axial sections 84 and 86. The sections 84 and 86 are sloped downward so that their centerlines 88 and 90, respectively, extend at an angle of about 92 degrees to the vertical, or two degrees downward from horizontal (horizontal is indicated by the line 92). The two sections 84 and 86 are joined by a drainage section 94 as described below. This configuration allows the sections 84 and 86 to be run in a ceiling, hidden from view, with the drainage section 94 dropping down into the room below—a typical setup in a pharmaceutical manufacturing plant.

The drainage section 94 of the system 10 includes an 88° fitting 100 that is connected to the outlet (downhill) end 102 of the pipe section 84. The lower end 104 of the 88° fitting 100 extends vertically. A 92° fitting 106 is connected to the inlet (uphill) end 108 of the section 86. The lower end 110 of the 92° fitting 106 extends vertically.

Because the lower ends 104 and 110 of the two fittings 100 and 106, respectively, are vertical, they can easily be connected by nominal 90° elbows 112 and 114 and a valve 116. The valve 116 can be used for tapping the flow of liquid through the section 88 to obtain a sample, or for use in processing. The valve 116 can alternatively be used for draining the system 80. Liquid in the system 80 that is upstream of the valve 116, in the fitting 100 and in the section 84, drains downhill into the valve and can be let out through the valve. Liquid in the system that is between the valve 116 and the downstream (upper) end of the 92° fitting 106 also drains downhill into the valve and can be let out through the valve. Other liquid in the system portion 80 shown in FIG. 6 drains down the section 86.

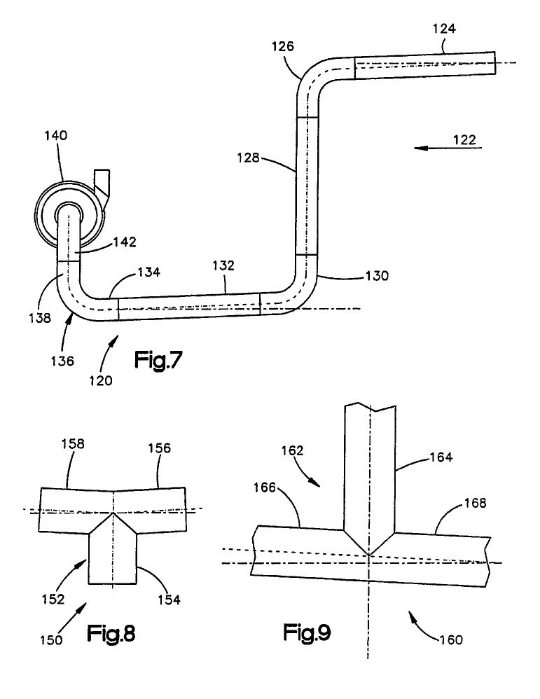

FIG. 7 illustrates a portion of another fluid system 120 that provides an example of use of fittings in accordance with the present invention. In the fluid system 120, liquid flows in a right to left direction as viewed in FIG. 7, as indicated by the arrow 122.

The system 120 includes a section 124 that is sloped downward at two degrees below the horizontal. An 88° fitting 126 is connected to the outlet end of the pipe section 124 to provide for connection of a vertical drop 128. From the lower end of the vertical drop 128, another 88° fitting 130 is connected to another section 132 that again is sloped downward at two degrees below the horizontal. Thus, the two nominal 88° fittings 126 and 130 can be used to provide for a vertical drop between two sloped sections.

The inlet end 134 of a nominal 92° fitting 136 is connected to the outlet end of the sloped section 132. The outlet end 138 of the 92° fitting 136 extends vertically. Because the upper (outlet) end 138 of the fitting 136 is vertical, it can easily be connected to a pump 140 having a standard vertically mounted inlet 142. Alternatively, another vertically extending system component can be connected with the outlet end 138 of the 92° fitting 136. Thus, the nominal 92° fitting 136 can be used to provide a vertical outlet from a sloped pipe section.

FIG. 8 illustrates a portion of a fluid system 150 that provides another example of use of fittings in accordance with the present invention. The system 150 includes a fitting 152. The fitting 152 has a generally Y-shaped configuration including a lower leg 154 and two upper legs 156 and 158. The upper legs 156 and 158 extend transverse to the lower leg 154. At least one of the upper legs 156 and 158 extends at a nominal angle, other than a right angle, to the lower leg 154. In the illustrated embodiment, both of the upper legs 156 and 158 extend at a nominal angle other than a right angle to the lower leg 154. Specifically, both of the upper legs 156 and 158 extend at a nominal angle of 92° to the center axis of the lower leg 154. As a result, both of the upper legs 156 and 158 drain into the lower leg 154 when the lower leg is mounted vertically. The fitting 152 is useful in draining two tube sections or pipe sections (not shown) that are attached to the upper legs 154 and 156 and that slope downward at an angle of two degrees below the horizontal.

FIG. 9 illustrates a portion of a fluid system 160 that provides another example of use of fittings in accordance with the present invention. The system 160 includes a fitting 162. The fitting 162 has an upside down generally T-shaped configuration including an upper leg 164 and two lower legs 166 and 168. The lower legs 166 extend transverse to the upper leg 164. At least one of the lower legs 166 and 168 extends at an angle, other than a right angle, to the upper leg 164. In the illustrated embodiment, both of the lower legs 166 and 168 extend at an angle other than a right angle to the upper leg 164. Specifically, one of the lower legs 166 extends at an angle of 88° to the upper leg 164, and the other lower leg 168 extends at an angle of 92° to the upper leg. As a result, the lower leg 168 drains both the upper leg 164 and the other lower leg 166 when the upper leg is mounted vertically. The fitting 162 is useful in draining a device or other system portion (not shown) attached to the upper leg 164, into a line that slopes downward and that includes, in the illustrated embodiment, the two lower legs 166 and 168.

It is important to note that while the exemplary embodiments herein are described in terms of exemplary nominal values and ranges of the included angle, these are not intended to be limiting in scope, other than being different from a nominal right angle and conventional tolerances. For example, it is contemplated that a nominal included angle of 87°±0.4, or 88.5±0.5 or 91.5±0.5 and so on are within the scope of the invention as is the exemplary range of 88°±0.5. Thus, one skilled in the art may select any desired nominal value and tolerance range other than a nominal 90° or right angle to assure drainability of the fitting.

From the above description of the invention, those skilled in the art will perceive improvements, changes, and modifications in the invention. Such improvements, changes, and modifications within the skill of the art are intended to be included within the scope of the appended claims.

1. A fitting for tube or pipe, said fitting having a first straight end section positioned along a first centerline and a second straight end section positioned along a second centerline, the included angle between the first centerline and the second centerline differs from a right angle by about 2 degrees±½ degree;
wherein said fitting is formed as a single piece.

2. The fitting of claim 1 wherein said included angle is a nominal value of about 88°±0.5°.

3. The fitting of claim 1 wherein said included angle is a nominal value of about 92°±0.5°.

4. The fitting of claim 1 wherein at least one of said straight end sections has an end face that is generally normal to a central longitudinal axis thereof.

5. The fitting of claim 1 wherein each of said straight end sections has a respective end face that is generally normal to a central longitudinal axis thereof.

6-16. (canceled)

17. A method of making a drainable fitting, comprising the steps of:
forming a fitting having straight end sections that extend at about a right angle to each other; and
bending the first straight end section of the fitting about two degrees relative to the second straight end section of the fitting.

18. A method of making a drainable fitting, comprising the steps of:
providing a straight length of conduit;
bending the straight length of conduit to form a fitting having first and second straight end sections that extend at an angle to each other of about two degrees more or less than a right angle; and
finishing the fitting.

19. A method of making a drainable fitting, comprising the steps of:
providing a fitting having first and second straight sections that are joined by about a 90 degree curved section and that extend at about a right angle to each other;
cutting the fitting along a cut line to remove the first straight section and an adjacent portion of the curved section; and
attaching a straight section to the fitting along the cut line thereby to form a fitting having first and second straight sections that are joined by a curved section of less than about 90 degrees.

20. The method of claim 19 wherein said step of attaching a straight section to the fitting is performed by orbital welding.

21. The fitting of claim 1 wherein each one of said straight end sections being orbitally weldable.

22. The method of claim 17 wherein the step of forming a fitting further comprises:
providing a straight length of conduit;
bending the straight length of conduit such that a portion of the conduit includes a first and second straight section that are joined by about a 90 degree curved section;
cutting the conduit to form a fitting having first and second straight end sections that extend at about a 90 degree angle to each other.
